(19) United States
(12) Patent Application Publication
(10) Pub. No.: US 2013/0003221 A1
(43) Pub. Date: Jan. 3, 2013

(54) FLY HEIGHT CONTROL USING WRITE VOLTAGE ADJUSTMENTS

(75) Inventors: Myoung Mee Kim, Seongnam-si (KR); Sang Tae Kim, Suwon-si (KR)

(73) Assignee: SEAGATE TECHNOLOGY INTERNATIONAL, Cupertino, CA (US)

(21) Appl. No.: 13/539,209

(22) Filed: Jun. 29, 2012

(30) Foreign Application Priority Data
Jun. 30, 2011 (KR) 10-2011-0065077

(51) Int. Cl. G11B 21/02

(52) U.S. Cl. 360/75; G9B/21.003

(57) ABSTRACT

Apparatus and method for controlling a fly height of a transducer adjacent a recording surface by adjusting a write voltage magnitude. In accordance with some embodiments, a write voltage with an initial magnitude is applied to a transducer. A write voltage change interval and a write voltage change amount are selected. The magnitude of the applied write voltage is thereafter successively reduced by the write voltage change amount over each of a plurality of successive write voltage change intervals.

### RELATED APPLICATIONS

The present application makes a claim of foreign priority under 35 U.S.C. §119(a) to Korean Patent Application No. 10-2011-0065077 filed Jun. 30, 2011.

### BACKGROUND

A hard disk drive is a memory device, including an electronic device and a mechanic device and records, which changes a digital electronic pulse into a permanent magnetic field to record and reproduce data. Since a hard disk drive can access a large amount of data at a high speed, it is widely used as an auxiliary memory device, or the like, of a computer system.

As a capacity of a hard disk drive has increased, the size of a read/write sensor of a magnetic head is reduced and a flying height (FH) of a magnetic head tends to be gradually lowered.

Namely, in order to manufacture a high capacity hard disk drive, when a high TPI Tracks/inch) or BPI (Bits/inch) is implemented, the width of tracks is reduced. When the width of tracks is reduced, the strength of a magnetic field weakens, so when the flying height rises, it s difficult to detect a magnetic field to result in a failure of a smooth operation of the hard disk drive.

For these reasons, research into a method for effectively reducing a spacing loss between a disk and a magnetic head has been actively conducted. Namely, a method for reducing a flying height of a magnetic head with respect to a disk is studied as a condition precedent for maximizing read/write performance with respect to a magnetic head.

In order to actively adjust a flying height of a magnetic head with respect to a disk, first, a flying height of a magnetic head should be estimated. In order to estimate a flying height of a magnetic head, a method for controlling a protrusion of a magnetic head by using a heater sensor within a slider has been adopted. This method has been an effective and useful solution for adjusting a required flying height.

In the case of this method, a certain voltage (an FOD (Flying On Demand) voltage) is applied to a heater coil installed in a magnetic head to drive a hard disk drive, and while the hard disk drive is being operated, a pole tip, i.e., an end portion, of the magnetic head is thermally expanded to reduce a flying height of the magnetic head, and here, the flying height is estimated by using the reduction characteristics of the flying height of the magnetic head. This technique is called FOD.

Employing FOD, in the general related art, the FOD voltage of a magnetic head is gradually increased to be applied, and an applied voltage when the pole top of the magnetic head is in contact with a flat surface of a disk is measured as a maximum FOD voltage. Substantially, an FOD voltage of an appropriate level lower than the maximum FOD voltage was estimated and uniformly applied to the magnetic head.

However, in actuality, the flying height of a magnetic head is not uniform and each expansion degree of FOD varies, considerably making it difficult to apply FOD in the foregoing manner.

In particular, when the FOD voltage is uniformly applied to the magnetic head, if the flying height of the magnetic head is excessively lowered, a so-called HDI (Head Disk Interface) may occur such that physical impact occurs between the magnetic head and the disk while the hard disk drive is being operated. Conversely, when the flying height of the magnetic head is too high or when a thermally expanded degree of the pole tip, an end portion of the magnetic head, is not protruded by a desired level, it may be difficult to secure an actually desired gap between the magnetic head and the disk.

Also, there are various methods for detecting how much a gap between a magnetic head and a disk can be narrowed in applying a certain voltage and to what extent an FOD voltage can be applied, in order to determine an appropriate FOD voltage. The FOD voltage may greatly vary according to an RPM of spindle motor with a disk mounted thereon or an external environment, and repeatability thereof is not good, so in order to solve this problem, various methods have been proposed to date.

### SUMMARY

Various embodiments of the present disclosure are generally directed to controlling a fly height of a transducer adjacent a recording surface by adjusting a write voltage magnitude.

In accordance with some embodiments, a write voltage with an initial magnitude is applied to a transducer. A write voltage change interval and a write voltage change amount are selected. The magnitude of the applied write voltage is thereafter successively reduced by the write voltage change amount over each of a plurality of successive write voltage change intervals.

Other features and advantages of various embodiments will become more apparent from the following detailed description when taken in conjunction with the accompanying drawings.

### BRIEF DESCRIPTION OF THE DRAWINGS

FIG. 1 is an exploded perspective view of a data storage device in accordance with an embodiment of the present disclosure.

FIG. 2 is a schematic block diagram of the device of FIG. 1 in accordance with some embodiments.

FIG. 3 is a block diagram showing a portion of a driving circuit of FIG. 2.

FIG. 4 is a signal diagram showing signals for controlling a flying height of a magnetic head according to some embodiments.

FIG. 5 is a flow chart illustrating a fly height control (FHC) method in accordance with some embodiments.

FIG. 6 is a block diagram or a computer system including a hard disk drive (HDD) and a memory device according to some embodiments.

### DETAILED DESCRIPTION

Particular structural or functional descriptions of embodiments according to the present disclosure are merely illustrative, and the subject matter of the disclosure may be implemented in various forms and is not limited to the embodiments described herein.

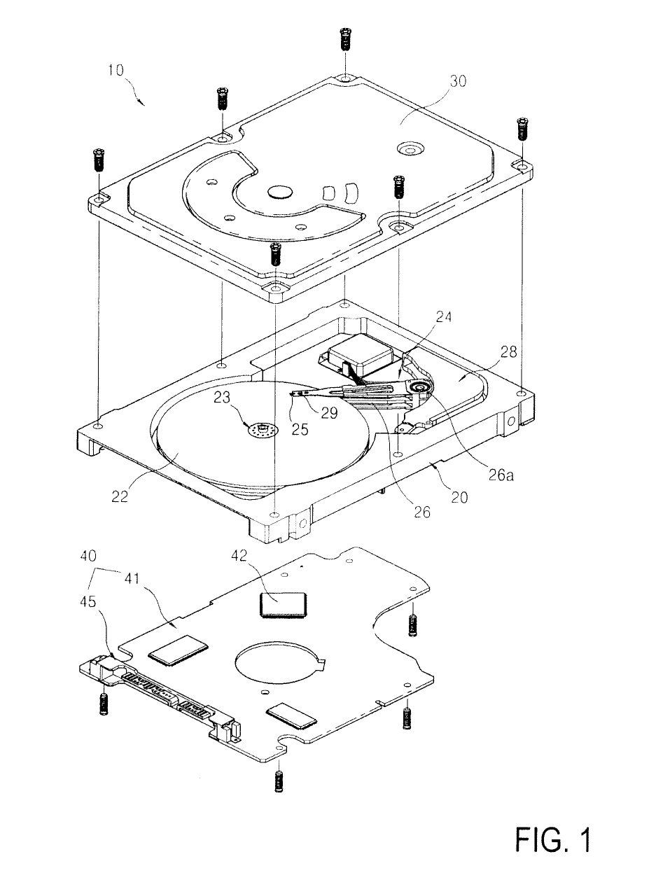

FIG. 1 is an exploded perspective view of a data storage device according to some embodiments of the present disclosure. The exemplary device is characterized as a hard disk drive 10 and may include a base 20, a cover 30 shielding an upper opening of the base 20, and a printed circuit board assembly (PCBA) coupled to a lower portion of the base 20.

The base includes a plurality of internal components related to reading and writing information mounted thereon. Namely, at least one disk 22 for recording and storing data, a spindle motor 23 provided in a central region of the disk 22 to rotate the disk 22, a head stack assembly 24 relatively n zing toward the disk 22. and the like.

The disk 22 has a discus-like shape. The disk 22 is an element in which data is recorded and stored. A plurality of disks 22 may be provided. A circular hole may be formed at the center of the disk 22, for a connection with a shaft of the spindle motor 23. The disk 22 is divided into a plurality tracks which are concentric based on the center of the disk. One track is divided into a plurality of sectors. The tracks on the disk 22 may be divided by zone, each being an aggregation of a plurality of tracks.

The disks 22 may include a plurality of layers. A smoothing layer, the uppermost layer, of the disk 22 may prevent a surface abrasion of the disk 22. A protective layer is a layer for protecting a magnetic layer 14. A touchdown sensing layer may sense a touchdown point of the magnetic head 25. The magnetic layer may be a layer magnetized in a vertical direction such that data is stored, and a soft under layer providing a path of a magnetic field in a horizontal direction to allow the magnetic layer to be smoothly magnetized up and down. An interlayer is provided to easily form the magnetic layer on the soft under layer, and a substrate, as a basic layer of the disk 22, may be made of hard glass or metal.

The spindle motor 23 may rotatably drive the disk 22 upon receiving a driving current. Rotation angular velocities of the spindle motor 23 include 3,600 rpm, 5400 rpm, 7200 rpm, 10000 rpm, or other suitable velocities,

In order to the spindle motor 23 to drive the disk 22, an axial portion (not shown) of the spindle motor 23 should be fixedly connected with the disk 22. Thus, a spindle motor hub may be provided. The spindle motor hub is coupled to an axial portion of the spindle motor 23, and here, the spindle motor may be coupled to the axial portion of the spindle motor 23 in a state in which an outer surface of the spindle motor hub and a circular hole formed at the center of the disk 22 are in contact with each other.

The head stack assembly 24 includes a magnetic head (transducer) 25 for recording data to a disk 22 or reproducing data from the disk 22, and an actuator 26 flying the magnetic head 25 to allow the magnetic head 25 to access data on the disk.

The magnetic head 25 may detect magnetic field formed on a surface of the disk 22 to reproduce data from the disk 22 or magnetize the surface of the disk 22 to record data to the disk 22. A plurality of magnetic heads 25 may be provided to correspond to the number of record faces of the disk 22.

The magnetic head 25 may be installed at a front end of a head gimbal 29 extendedly connected to the actuator 26, and when the plurality of disks 22 are rotated at a high speed, the magnetic head 25 is lifted according to an air current on the surface of the disk 22 and flies while maintaining an interval by a flying height (FH) with respect to the surface of the disk 22.

The flying height (FH) may be different for each magnetic head 25 according to physical properties of the respective magnetic heads 25. Even in case of the same magnetic head 25, the flying height may differ according to in which zone of the disk 22 the magnetic head 25 is positioned. This is because a linear velocity of each zone affecting levitation force of the magnetic head 25 is faster toward an outer zone. A coil may be installed in a pole tip of the magnetic head 25. The coil generates heat upon receiving an FOD voltage. Namely, the flying height may be changed by thermally expanding the pole tip of the magnetic head 25 by changing the FOD voltage.

The actuator 26 may be installed to be rotatable with respect to the disk 22 based on a pivot shaft 26a. Namely, when the actuator 26 is moved horizontally according to an operation of a voice coil motor (VCM) 28, the magnetic head 25 installed at the other end moves in a radial direction on the disk 22 to write or read data to and from the track on the disk 22.

The voice coil motor 28 may rotatably drive the actuator 26 based on the pivot shaft 26a. The voice coil motor 28 may rotate the actuator 26 in a direction following Fleming's left-hand rule according to electromagnetic force generated according to an interaction between a magnetic force line generated by a magnet and a current flowing through a voice coil.

Also, the voice coil motor 28 may be replaced by a stepper motor which rotatably drives the actuator 26 by certain angle each time according to an input signal. Here, the use of the voice coil motor 28 has advantages in that it is resistant to heat, is not necessarily formatted periodically, and has excellent reliability.

The PCBA 40 includes a PCH 41 on which a plurality of circuit components are mounted and a plug 45 coupled to one side of the PCH 41. A controller 42 handling various controlling operations of the hard disk drive 10 is provided as the plurality of circuit components on a surface of the PCB 41. Although not shown, a memory storing various data and tables may be positioned in the vicinity of the controller 42.

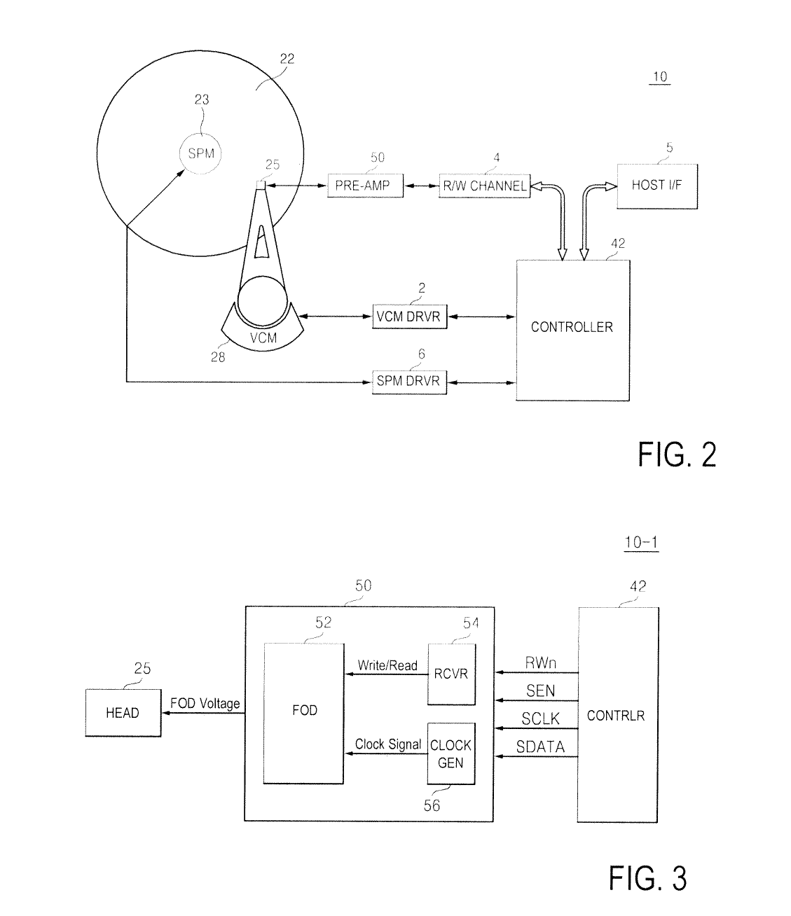

FIG. 2 is a schematic block diagram of a hard disk drive driving circuit according to an embodiment of the present disclosure.

The hard disk drive 10 may further include a pre-amplifier (pre-amp) 50, a read/write (R/W) channel 4, a host interface (I/F) 5, a VCM driving unit (drvr) 2, an SPM driving unit (drvr) 6, and a controller 42 controlling these elements.

The pre-amplifier 50 may amplify a data signal reproduced by the magnetic head 25 from the disk 22. The pre-amplifier 50 may amplify a record current converted by the read/write channel 4 and record the same on the disk 22. Also, the pre-amplifier 50 may control the controller 42 to supply an FOD voltage to the coil installed in the pole tip of the magnetic head 25. The pre-amplifier 50 according to an embodiment of the present disclosure will be described in detail with reference to FIG. 3.

The read/write channel 4 may convert the signal amplified by the pre-amplifier 50 into a digital signal and transmit the converted digital signal to the host device through the host interface 5. The read/write channel 4 may receive data input by the user through the host interface 5, convert the received data into a binary data stream that can be easily written, and input the same to the pre-amplifier 50.

Namely, the read/write channel 4 converts a signal amplified by the pre-amplifier 50 after being reproduced from the disk 22 by the magnetic head 25 into a digital signal in a data read mode and input the converted digital signal to the controller 42. The read/write channel 4 may receive a user input data received by the host interface 5 in a data write mode through the controller 42, convert the received data into a binary data stream that can be easily written, and output the same to the pre-amplifier 50.

The host device is used to have a meaning generally designating a device that generally controls and operates the entire computer including a hard disk drive 10 such as a CPU of a computer or an I/O controller.

The host interface 5 may transmit the data which has been converted into a digital signal to the host device, or receive the user input data from the host device and output the same to the read/write channel 4 through the controller 42.

The VCM driving unit 2 may adjust an amount of a current applied to the voice coil motor 28 upon receiving a control signal from the controller 42.

The SPM driving unit 6 may adjust an amount of a current applied to the spindle motor 23 upon receiving a control signal of the controller 42.

In the data write mode, the controller 42 may receive user input data input from the host device through the host interface 5 and output the received data to the read/write channel 4. In the data read mode, when the read/write channel 4 converts the data signal amplified by the pre-amplifier 50 into a digital signal, the controller 42 receives the converted digital signal and outputs the same to the host interface 5.

Also, the controller 42 inputs a voice coil motor control signal to the VCM driving unit 2 to control driving of the voice coil motor 28, and inputs a spindle motor control signal to the SPM driving unit 60 to control driving of the spindle motor

Also, the controller 42 may input an FOD voltage control signal to the pre-amplifier 50 to control the pre-amplifier 50 to supply an FOD voltage to the magnetic head 25. The FOD voltage control signal generated from the controller 42 may be directly input to the pre-amplifier 50 or may be input to the pre-amplifier 50 through the read/write channel 4.

The controller 42 may be a micro-processor, a micro-controller, or the like.

FIG. 3 is a block diagram showing a portion of the hard disk drive driving circuit according to an embodiment of the present disclosure.

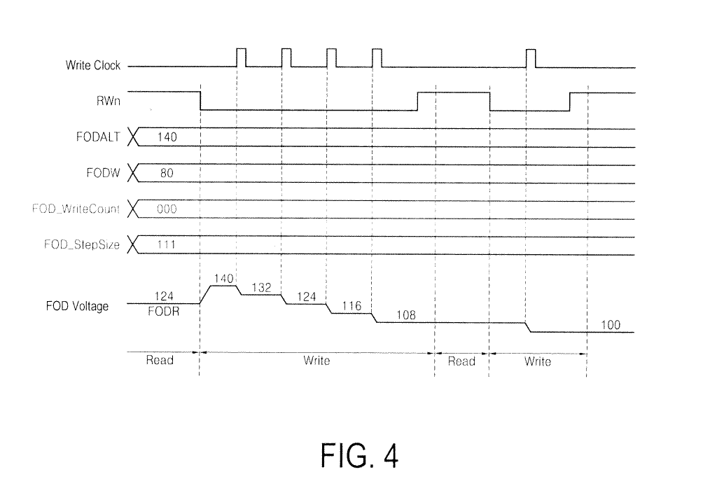

FIG. 4 is a signal diagram showing signals for controlling a flying height of a magnetic head according to an embodiment of the present disclosure.

With reference to FIG. 3, a portion 10-1 of the hard disk drive 10 according to an embodiment of the present disclosure may include the pre-amplifier 50, the controller 42 transmitting a plurality of signals to the pre-amplifier 50, and the magnetic head 25 that writes data or reads written data upon receiving the FOD voltage output from the pre-amplifier 50.

Also, the pre-amplifier 50 according to an embodiment of the present disclosure may include a receiving unit 54 receiving a data read or data write command signal from the outside, a clock signal generating unit 56 generating an internal clock signal based on a pre-set clock rate, and an FOD block 52 setting a site of an initial write voltage among the FOD voltages according to the generated internal clock signal, and setting an amount with respect to a change in the initial write voltage.

During a data write operation, the controller 42 may receive data output from the main processor, convert the received data into a plurality of signals that may be processed in the pre-amplifier 50, and transmit various converted signals to the pre-amplifier 50.

With reference to FIG. 3, an SDATA signal refers to serial data transmitted to the pre-amplifier in response to a serial clock signal SCLK, and SEN refers to an enable signal. When the enable signal SEN is activated to have a high level, the pre-amplifier 50 may receive the serial data SDATA input in response to the serial clock signal SCLK, interpret, and perform an operation according to interpretation results.

An RWn signal is an access signal indicating an access operation. For example, the pre-amplifier 50 may perform a write operation in response to the access signal having a low level, and perform a read operation in response to an address signal having a high level.

The receiving unit 54 may receive a plurality of signals input from the controller 42. the receiving unit 54 may transmit the received signals to the FOD block 52.

The clock signal generating unit 56 may be positioned within the pre-amplifier 50 and generate a clock signal. In this case, the clock signal generating unit 56 may generate a clock signal base don a change in absolute time. In detail, when a data write command signal is received by the receiving unit 54, the clock signal generating unit 56 may generate at least one internal clock signal in any one write command signal among received data write command signals.

Namely, in case in which an FOD voltage level is adjusted when a write command signal is received, if the hard disk drive 10 undergoes a 4K long sector change in a short sector of 512 MB, write gates to which a write command signal is input are increased 8 times, making it impossible to accurately control the FOD voltage. According to an embodiment of the present disclosure, when any one write command signal is input to have a low level, an internal clock signal is generated at short intervals while the low level is maintained, thus accurately controlling the FOD voltage.

Also, the problem in which controlling of the FOD voltage is not uniform because the lengths of the write command signals having a low level are different in each zone of the disk can be solved.

The size of the initial write voltage may be changed according to a clock signal generated from the clock signal generating unit 56.

The FOD block 52 may set a size of an initial write voltage and a length with respect to a change in an initial write voltage according to the internal clock signal generated from the clock signal generating unit 56 positioned within the pre-amplifier 50. Also, the FOD block 52 may set an amount with respect to a change in the initial write voltage. The FOD block 52 may change the set size of the initial write voltage, the length with respect to a change, and the amount with respect to the change, and apply the same to the magnetic head 25.

For example, the FOD block 52 may set the size of the initial write voltage through a signal of FODALT. For example, as illustrated, the value of FODALT signal may be set to 140. A unit of this value may be Volt or W representing voltage or current, or may indicate a relative size. Namely, the number illustrated in the drawing to represent the size of a voltage or power may be variably modified and not limited thereto. When the FODALT signal is set to 140, when a write operation is performed in response to the access signal RWn having a low level, the FOD block 52 may set the size of the initial write voltage or power to 140.

Also, the FOD block 52 may set the length with respect to a change in the initial write voltage through an FOD_WriteCount signal. According to a type of the hard disk drive 10, the FOD block 52 may be set to change the size of a write voltage whenever one clock signal, among clock signals generated from the clock signal generating unit 56, and set to change the size of the write voltage whenever two clock signals are generated.

As illustrated, when FOD_WriteCount is 000, the size of the write voltage is regularly reduced whenever one internal clock signal is generated.

Also, the FOD block 52 may set an amount with respect to a change in the initial write voltage through FOD_StepSize signal. Namely, when a length with respect to a change in the initial write voltage is set, the size of the FOD voltage changing accordingly is set.

As illustrated, when FOD_StepSize is 111, the FOD voltage is reduced by 8 each time starting from the initial write voltage.

The FOD block 52 may set the size of the initial write voltage or power such that it is greater than the size of voltage (FODR) or power supplied to the magnetic head 25 during reading. Namely, the FOD block 52 may set the initial write voltage among the FOD voltages such that it is greater than the record voltage before the initial write voltage is applied. Namely, FODR is smaller than the value of FODALT in size.

The FOD block 52 may reduce the size of the initial write voltage according to the sequentially generated internal clock signal sequentially based on the set amount with respect to a change in the initial write voltage and apply the same to the magnetic head 25.

Also, when the changed size of the initial write voltage reaches the pre-set reference value (e.g., the FODW signal), the FOD block 52 may stop changing of the initial write voltage. The pre-set reference value may be set to a voltage or power required for a write operation.

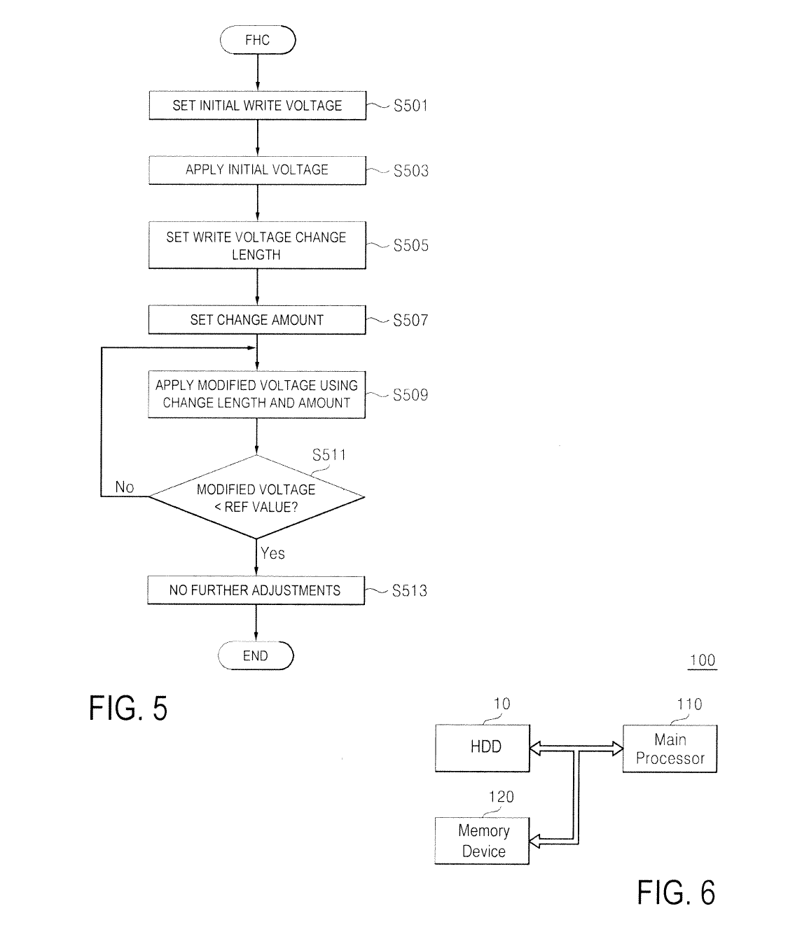

FIG. 5 is a flow chart illustrating a method of controlling a flying height of a magnetic head of the hard disk drive driving circuit according to an embodiment of the present disclosure.

The FOD block 52 of the pre-amplifier 50 may set an initial write voltage (S501). The controller 4 outside the pre-amplifier 50 may receive a data write command signal such that the set initial write voltage can be applied to the magnetic head 25 (S503).

When the data write command signal is received by the receiving unit 54 of the pre-amplifier 50, the clock signal generating unit 56 may generate an internal clock signal based on a pre-set clock rate. The internal clock signal may be generated at least one or more times within one period in which a single write command signal, among received data write command signals, is maintained.

The internal clock signal generated in the clock signal generating unit 56 is delivered to the FOD block 52, and the FOD block 52 may set a length with respect to a change in the initial write voltage according, to the generated internal clock signal (S505).

Also, the FOD block 52 may set an amount with respect to a change in the initial write voltage (S507). The FOD block 52 may apply the initial write voltage changed based on the set length and amount with respect to the change in the initial write voltage to the magnetic head 25 (S509). In detail, the FOD block 52 may reduce the initial write voltage according to the internal clock signal sequentially continuously generated based on the set amount with respect to the change in the initial write voltage.

The initial write voltage may be reduced by the set amount with respect to a change whenever the internal clock signal is generated. Also, when the internal clock signal is generated several times according to the set length with respect to the change, whether to reduce the initial write voltage is determined, and accordingly, the initial write voltage may be reduced by the set amount with respect to the change.

The initial write voltage changed based on the set amount and length with respect to the change may be compared with a pre-set reference value (S511).

According to the comparison results, when the changed size of the initial write voltage is still greater than the reference value, the initial write voltage reduced according to the previous internal clock signal is reduced again according to the set length and amount with respect to the change (S509).

According to the comparison results, when the changed size of the initial write voltage reaches the reference value, changing of the write voltage may be stopped (S513).

FIG. 6 is a block diagram of a computer system including a hard disk drive and a memory device according to an embodiment of the present disclosure.

The main processor 110 may control an operation of the hard disk drive 10 in order to write data to the disk of the hard disk drive 10 or read data from the disk.

Also, the main processor 110 may control an operation of the hard disk drive 10 in order to write data to the memory device 120 or read data from the memory device 120. Also, the main processor 110 may write data to the hard disk drive 10 or the memory device 120 as necessary.

The memory device 120 may be connected to a host, namely, the main processor, and the hard disk drive 10 through an interlace (not shown), and may include a DRAM (Dynamic Random Access Memory) and a nonvolatile memory (NVM). The nonvolatile memory may include an EEPROM, a flash memory, an MRAM (Magnetic RAM), an MRAM (Spin-Transfer Torque MRAM), an FeRAM (Ferroelectiric RAM), a PRAM (Phase change RAM), an RRAM (Resistive RAM), a nano-tube RRAM, a polymer RAM, a nano-floating gate memory), a holographic memory, a molecular electronics memory device), or an insulator resistance change memory.

The method for controlling a flying height of a head according to exemplary embodiments described above may be implemented in the form of programs which can be executed by various computer means, and recorded on a computer-readable medium. The computer-readable medium may include program commands, data files, data structures, alone, or a combination thereof. Program instructions recorded on the medium may be particularly designed and structured for the present disclosure or available to those skilled in computer software. Examples of the computer-readable recording medium include hardware devices, particularly configured to store and perform program commands, such as, magnetic media, such as a hard disk, a floppy disk, and a magnetic tape; optical media, such as a compact disk-read only memory (CD-ROM) and a digital versatile disc (DVD); magneto-optical media, such as floptical disks; a read-only memory (ROM); a random access memory (RAM); and a flash memory. Program commands may include, for example, a high-level language code that can be executed by a computer using an interpreter, as well as a machine language code made by a complier. The hardware devices may be configured to be operated by one or more software modules to implement the subject matter of the disclosure, and vice versa.

Various embodiments have been described with reference to the accompanying drawings, and it will be apparent to those skilled in the art that various modifications and variations can be made without departing from the scope of the disclosure. Thus, the technical concept of the present disclosure should be interpreted to embrace all such alterations, modifications, and variations in addition to the accompanying drawings.

What is claimed is:

1. A method comprising:
applying a write voltage to a transducer, the write voltage having an initial magnitude;
setting a write voltage change interval undo write voltage change amount; and
reducing the magnitude of the applied write voltage by the write voltage change amount over each of a plurality of successive write voltage change intervals to control a fly height of the transducer adjacent a recording surface.

2. The method of claim 1, in which the write voltage change interval is set responsive to a clock signal based on a pre-set clock rate when a data write command signal is received.

3. The method of claim 21, wherein the internal clock signal is generated at least once within a single write command signal among a plurality of received data write command signals.

4. The method of claim 1, wherein the initial write voltage is reduced according to an internal clock signal sequentially generated based on a set amount with respect to a change in the initial write voltage.

5. The method of claim further comprising stopping further reductions in the magnitude of the applied write voltage responsive to the magnitude reaching a pre-set reference value.

6. The method of claim 1, in which the transducer writes data to an adjacent recording medium using a sequence of write pulses having a magnitude corresponding to the magnitude or the applied write voltage.

7. The method of claim 1, further comprising asserting a write gate signal responsive to receipt of a write command to write data, and successively reducing the magnitude of the applied write voltage by the change amount for each change interval during the assertion of the write gate signal.

8. An apparatus comprising:
a transducer adjacent a data storage surface; and
a flying on demand (FOD) block adapted to apply a write voltage having an initial magnitude to the transducer, to set a write voltage change interval and a write voltage change amount, and to successively reduce the magnitude of the applied write voltage by the write voltage change amount over each of a plurality write voltage change intervals to control a fly height of the transducer.

9. The apparatus of claim 8, further comprising a receiver adapted to receive a data write signal, and a clock signal generating unit adapted to generate an internal clock signal based on a pre-set clock rate when the data write command signal is received, wherein the write voltage change interval is set responsive to the internal clock signal.

10. The apparatus of claim 9, in which the clock signal generating unit generates the internal clock signal at least once within a single data write command signal among a plurality of received data write command signals,

11. The apparatus of claim 8, in which the FOD block applies the write voltage at the initial magnitude to the transducer prior to receipt of a data rite command signal, and sets the write voltage change interval and the write voltage change amount responsive to subsequent receipt of a data write command signal.

12. The apparatus of claim 8, in which the FOD block stops reducing the magnitude of the applied write voltage responsive to a pre-set reference value.

13. The apparatus of claim 8, wherein the FOD block sets the initial write voltage among the FOD voltages such that the initial write voltage is greater than a record voltage before the write voltage is applied.

14. The apparatus of claim 8, in which the transducer writes data to the recording surface using a sequence of write pulses having a pulse magnitude corresponding to the magnitude of the applied write voltage.

15. The apparatus of claim 8, in which the FOD reduces the magnitude of the applied write voltage over a first change interval, compares the reduced magnitude to a pre-set reference value, and further reduces the magnitude of the applied write voltage over an immediately following second change interval responsive to said comparison.

16. The apparatus of claim 8, further comprising a control circuit adapted to assert a write gate signal responsive to receipt of a write command to write data, wherein the FOB block successively reduces the magnitude of the applied write voltage by the change amount for each change interval during the assertion of the write gate signal.

17. An apparatus comprising:
a receiving unit adapted to receive a data write command signal;
a clock signal generating unit adapted to generate a clock signal based on a pre-set clock rate responsive to receipt of a data write command; and
a flying on demand (FOD) block adapted to control a fly height of a transducer by applying an initial write voltage thereto and, responsive to receipt of the data write command signal, setting a write voltage change interval responsive to the pre-set clock rate and setting a write voltage change interval, the FOD block further adapted to adjust the magnitude of the applied write voltage by the write voltage change amount over each of a plurality of successive write voltage change intervals.

18. The apparatus of claim 17, characterized as a pre-amplifier in a data storage device comprising a transducer coupled to the pre-amplifier to receive said applied write voltage to write data to an adjacent recording surface.

19. The apparatus of claim 17, in which the FOD reduces the magnitude of the applied write voltage over a first change interval, compares the reduced magnitude to a pre-set reference value, and further reduces the magnitude of the applied write voltage over an immediately following second change interval responsive to said comparison.

20. The apparatus of claim 17, further comprising a control circuit adapted to assert a write gate signal responsive to receipt of a write command to write data, wherein the FOB block successively reduces the magnitude of the applied write voltage by the change amount for each change interval during the assertion of the write gate signal.
